(19) United States
(12) Patent Application Publication
(10) Pub. No.: US 2006/0261567 A1
(43) Pub. Date: Nov. 23, 2006

(54) Industrial tank dolly device

(75) Inventors: Derek C. Knox, Lehi, UT (US); Steven R. Hutchinson, Salt Lake City, UT (US)

Correspondence Address: ALAN J. HOWARTH, P.O. BOX 1909, SANDY, UT, 84091-1909, US

(73) Assignee: Overstock.com, Inc.

(21) Appl. No.: 11/134,185

(22) Filed: May 20, 2005

(51) Int. Cl. B62B 1/00

(52) U.S. Cl. 280/47.131

(57) ABSTRACT

A two-piece tank dolly for transporting heavy objects such as industrial cylindrical tanks. The device comprises a base assembly that is removably attachable to a bottom portion of the cylindrical tank. The base assembly further comprises a pair of wheels attached to a frame. The frame includes a support for receiving the tank. A separate handle assembly is also removably attachable to an upper portion of the tank by a strap or other similar device. The handle assembly includes at least one handle which is used by a person to control the tank during transport. The handle assembly may also include a mechanism to lock and release the handle assembly from around the tank.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

The present disclosure relates generally to devices for transporting elongated cylindrical tanks, and more particularly, but not necessarily entirely, to wheeled devices that are removably attachable to cylindrical tanks.

Conventional tank dollies, also referred to in the industry as tank carts and tank trucks, are well known by those skilled in the art. Tank dollies are wheeled devices that allow heavy objects, such as industrial cylindrical tanks, to be easily transported from location to location. A tank dolly typically comprises a pair of wheels attached to a metal frame. The frame generally includes a bottom support upon which a tank may sit or rest. The bottom support also engages the ground to allow the tank to stand in an upright position.

The frame of a dolly also generally includes a handle connected to the bottom support by support risers in a rigid configuration. This configuration allows a user to tilt the dolly rearward to rotate the bottom support off the ground so that the weight of the tank rests entirely on the pair of wheels. In this manner, the user may wheel the tank to the selected location with all of the weight of the tank and dolly supported by the wheels.

Examples of previously known tank dollies are disclosed in U.S. Pat. No. 4,666,179, granted to Adams; U.S. Pat. No. 5,431,422, granted to Gamache; and U.S. Pat. No. 4,650,200, granted to Berfield et al. These patents each disclose a wheeled device having a support frame with an integrated handle. Other similar devices are disclosed in U.S. Pat. No. 2,131,673, granted to Robinson; U.S. Pat. No. 6,508,477, granted to Burkett; U.S. Pat. No. 5,393,080, granted to Ross; U.S. Pat. No. 6,047,983, granted to Day III; and U.S. Pat. No. 4,815,761, granted to Henderson et al. Again, each of the above disclosed devices includes a single frame that interconnects the wheels and the handle.

Other devices for transporting cylindrical tanks are also known. These devices include a wheeled bottom portion that has no handle for a user to grasp during transport. Instead, the user grasps the tank or the tank valve on the top of the tank. Disadvantageously, this does not provide a secure grip for the user, which may result in the tank toppling over. Examples of these devices are found in U.S. Pat. No. 5,292,140, granted to Laing; U.S. Pat. No. 5,131,670, granted to Clements et al.; U.S. Pat. No. 3,301,570, granted to Berman; U.S. Pat. No. 4,544,173, granted to Kellermyer; and U.S. Pat. No. 2,396,368, granted to Gorrell et al.

Despite the advantages of known tank dollies and other transport devices, improvements are still being sought. For example, it would be beneficial to reduce the consumption of materials during manufacture, especially metal. In addition, it would be useful to provide a wheeled base assembly and a separate handle assembly to thereby take advantage of the support offered by the tank itself. Another improvement would allow convenient and compact transport of the dolly itself.

The features and advantages of the disclosure will be set forth in the description that follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF SUMMARY OF THE INVENTION

An illustrative embodiment of the invention relates to an apparatus for transporting a tank, the tank having a top, a bottom, and a sidewall, the apparatus comprising:

a base assembly configured and dimensioned to removably engage the bottom of the tank, the base assembly comprising a pair of wheels and a frame; and

a handle assembly configured and dimensioned to removably engage the sidewall of the tank, the handle assembly comprising at least one handle;

wherein the base assembly and the handle assembly are not rigidly interconnected.

Another illustrative embodiment according to the present invention comprises an apparatus for transporting a tank, the tank having a top, a bottom, and a sidewall, the apparatus comprising:

a base assembly configured and dimensioned to removably engage the tank, the base assembly comprising a pair of wheels and a frame, the frame comprising a bottom support member for engaging the bottom of the tank and a side support member for engaging the sidewall of the tank, the frame further comprising at least one arm pivotally attached to the frame, the at least one arm operable between an open position and a closed position, the at least one arm securing the tank to the frame when the at least one arm is in the closed position; and

a handle assembly configured and dimensioned to removably engage the tank, the handle assembly comprising at least one handle and a strap, the strap operable to secure the at least one handle to the tank;

wherein the base assembly and the handle assembly are separately attachable to the tank.

Still another illustrative embodiment of the invention comprises an apparatus for transporting a tank, the tank having a top, a bottom and a sidewall, the apparatus comprising:

a first means for securing a pair of wheels to the bottom of the tank; and

a second means for securing at least one handle to the tank;

wherein the first and second means are not rigidly interconnected.

### BRIEF DESCRIPTION OF THE SEVERAL VIEWS OF THE DRAWINGS

The features and advantages of the disclosure will become apparent from a consideration of the subsequent detailed description presented in connection with the accompanying drawings in which:

FIG. 1 is a perspective view of an exemplary base assembly and handle assembly mounted on a tank made in accordance with the principles of the present invention;

FIG. 2 is a perspective view of the exemplary base assembly shown in FIG. 1;

FIG. 3 is the same perspective view of the base assembly in FIG. 2 showing a feature of the base assembly;

FIG. 4 is a front perspective view of another exemplary embodiment of a base assembly;

FIG. 5 is a top view of the base assembly shown in FIG. 4;

FIG. 5A is a cross-sectional view taken along the plane A-A of FIG. 5;

FIG. 6 is a front perspective view of another exemplary embodiment of a base assembly;

FIG. 7 is a rear perspective view of the base assembly shown in FIG. 6;

FIG. 8 is a perspective view of the exemplary handle assembly shown in FIG. 1;

FIG. 9 is a top view of the handle assembly shown in FIG. 8;

FIG. 10 is a side view of the handle assembly shown in FIG. 8;

FIG. 11 is a partially exploded view of the handle assembly shown in FIG. 8;

FIG. 12 is a fragmented top view of a strap and lever assembly of the handle assembly shown in FIG. 8;

FIG. 12A is a fragmented side view of a strap and lever assembly of the handle assembly shown in FIG. 8;

FIG. 13 is a perspective view of another exemplary embodiment of a handle assembly;

FIG. 14 is a perspective view of an exemplary base assembly and a strap with a handle both installed on a tank in accordance with the principles of the present invention;

FIG. 15 is a perspective view of an exemplary base assembly and a strap connected to a removable tank protection ring, which are all installed on a tank in accordance with the principles of the present invention;

FIG. 16 is a perspective view of another exemplary embodiment of a base assembly; and

FIG. 17 is a perspective view of a tank guard assembly installed on a tank.

### DETAILED DESCRIPTION

Before the present apparatuses are disclosed and described, it is to be understood that this invention is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present invention will be limited only by the appended claims and equivalents thereof.

The publications and other reference materials referred to herein to describe the background of the invention and to provide additional detail regarding its practice are hereby incorporated by reference. The references discussed herein are provided solely for their disclosure prior to the filing date of the present application. Nothing herein is to be construed as an admission that the inventors are not entitled to antedate such disclosure by virtue of prior invention.

It must be noted that, as used in this specification and the appended claims, the singular forms “a,” “an,” and “the” include plural referents unless the context clearly dictates otherwise. Thus, for example, reference to an apparatus comprising “a handle” includes reference to two or more of such handles, reference to “a lever” includes reference to two or more of such levers, and reference to “a strap” includes references to two or more of such straps.

In describing and claiming the present invention, the following terminology will be used in accordance with the definitions set out below.

As used herein, “comprising,” “including,” “containing,” “characterized by,” and grammatical equivalents thereof are inclusive or open-ended terms that do not exclude additional, unrecited elements or method steps. “Comprising” is to be interpreted as including the more restrictive terms “consisting of” and “consisting essentially of.” As used herein, “consisting of” and grammatical equivalents thereof exclude any element, step, or ingredient not specified in the claim. As used herein, “consisting essentially of” and grammatical equivalents thereof limit the scope of a claim to the specified materials or steps and those that do not materially affect the basic and novel characteristic or characteristics of the claimed invention.

For the purposes of promoting an understanding of the principles in accordance with the disclosure, reference will now be made to the embodiments illustrated in the drawings and specific language will be used to describe them. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Applicant has invented a device for transporting cylindrical tanks having many useful features, especially when utilized in conjunction with industrial type tanks. In one embodiment, the invention provides a base assembly having a pair of wheels mounted on an axle. In this embodiment, the base assembly is configured to removably attach to a lower portion of the tank. Another embodiment of the invention provides a separate handle assembly mountable in a location proximate to the top of the tank. In this embodiment, the handle assembly easily attaches to the tank by, for example, a strap. In this and other embodiments, the handle assembly may comprise a means for tightening and clamping the strap to the tank. When used together, the base and handle assemblies facilitate the transport of a tank. An illustrative embodiment of the invention is also unique in that it provides a handle assembly having an integrated roller to allow the tank to be transported in the horizontal position.

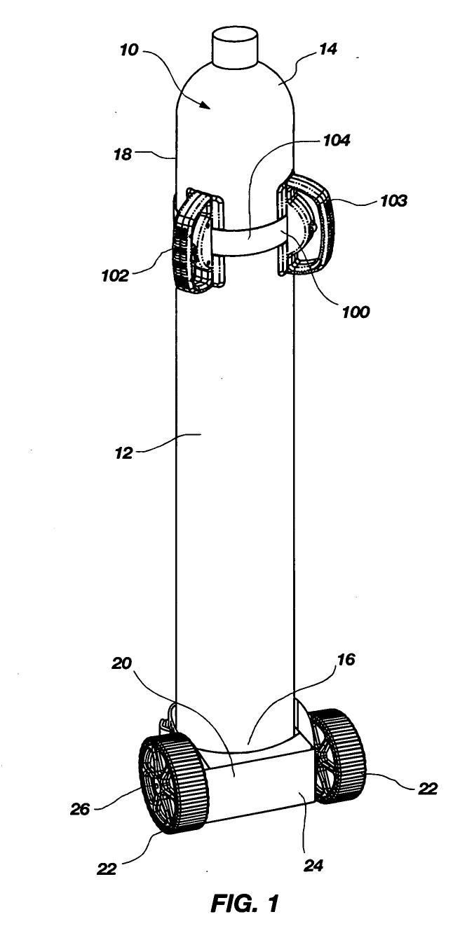

Referring now to the drawings, there is shown in FIG. 1 an exemplary embodiment of the invention installed on a tank 10. The tank 10 may be of conventional design, including a cylindrical body 12 having a sidewall 18 extending between a top 14 of the tank 10 and a bottom 16 of the tank 10. The tank 10 may hold any substance in a gas state, such as oxygen, acetylene, helium, or propane, as is well known by those skilled in the art. The invention includes a base assembly 20 and a handle assembly 100 that are each separately mounted on the tank 10.

As mentioned, the base assembly 20 is installed on the bottom 16 of the tank 10. The base assembly 20 includes a pair of wheels 22 that may be mounted on an axle 26. The base assembly 20 also includes a support frame 24. The handle assembly 100 is also mounted on the tank 10. The handle assembly 100 comprises two handles 102 and 103 and a strap 104. The strap 104 secures the handles 102 and 103 to the body 12 of the tank 10. The features and components of both the base assembly 20 and handle assembly 100 will now be discussed in more detail below.

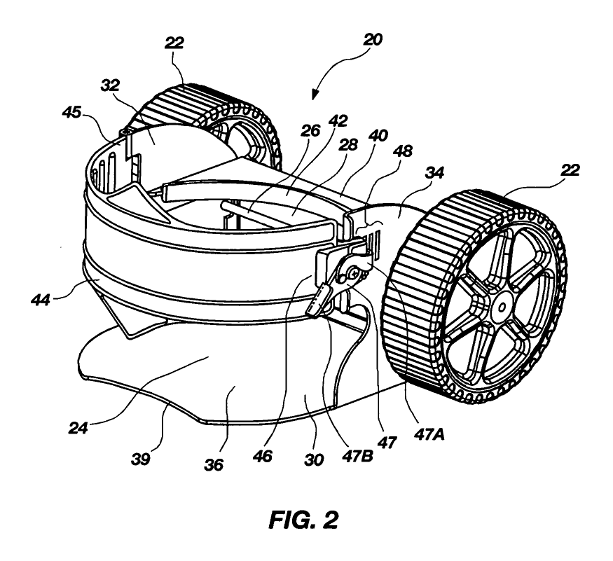

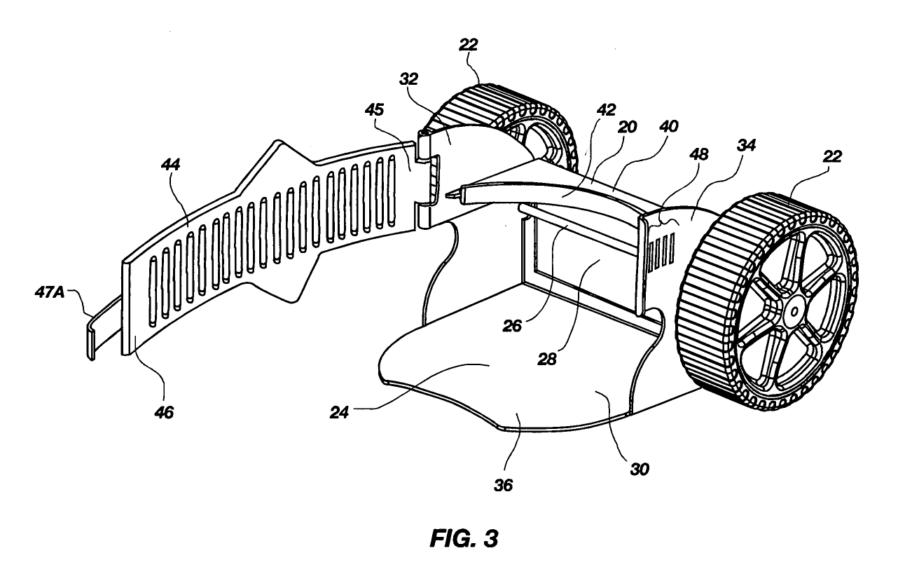

Referring now to FIGS. 2 and 3, there is shown a perspective view of base assembly 20. Support frame 24 includes a rear support 28 extending upward from a bottom support 30. A first side support 32 and a second side support 34 also extend upward from the bottom support 30. The first side support 32 and second side support 34 are disposed on opposite lateral sides of the bottom support 30. The first side support 32 and second side support 34 also extend forward from the rear support 28.

The axle 26 extends horizontally through the first and second side supports, 32 and 34, respectively, such that the ends of the axle 26 extend beyond the frame 24. Wheels 22 are mounted on the portions of the axle 26 extending outside of the frame 24. It should be noted that the wheels may be of any conventional design as is known to those skilled in the art.

The bottom support 30 is illustratively constructed of a thin planar material having a top portion 36 and a bottom portion (not shown). The bottom support 30 extends forward from the rear support 28. The top portion 36 serves as a platform to receive the end of tank 10. Most often, the end of tank 10 simply rests on the top portion 36. The bottom portion of the bottom support 30 engages the ground to thereby provide a stable base for the base assembly 20 to thereby maintain the tank 10 in an upright position. Thus, the bottom support 30 should be of sufficient size to fulfill this purpose. A forward-most portion 39 of the bottom support 30 is slightly concave to facilitate loading the tank 10 onto and off of the bottom support 30.

Disposed proximately to the top of the rear support 28 is a tank-engaging member 40. Tank-engaging member 40 extends forward from the rear support 28 and generally parallel to the bottom support 30. The tank-engaging member 40 also extends laterally between the first side support 32 and second side support 34. A forward most portion 42 of the tank-engaging member 40 has a curvature configured to engage the cylindrical body 12 of the tank 10.

A first end 45 of an arm 44 is pivotally mounted to the first side support 32. Arm 44 has a curvature, like the forward-most portion 42, configured to engage the cylindrical body 12 of the tank 10. As shown in FIG. 2, a second end 46 of arm 44 includes a fastener 47 that engages the second side support 34 of the frame 24. Fastener 47 may include a latch 47A movable by a lever 47B. Latch 47A engages one of a plurality of receiving holes 48 in the second side support 34. The receiving holes 48 are staggered to thereby allow the base assembly 20 to be utilized with tanks of various diameters. It will be appreciated that fastener 47 may include any fastening mechanism now known or known in the future to those skilled in the art, including, without limitation, a hook-and-loop strap, a nut and bolt, a shaft and a cotter pin, a snap, a tie, and a catch.

As seen in FIGS. 2 and 3, respectively, the arm 44 is positionable between a closed position and an open position. In the closed position, the arm 44, the forward-most portion 42, and the bottom support 30 engage the tank 10 to thereby secure the base assembly 20 to the tank 10 as is shown in FIG. 1. Fastener 47 secures the arm 44 tightly around the tank 10 to prevent the tank 10 and the base assembly 20 from disengaging. With the arm 44 in the open position, as shown in FIG. 3, the tank 10 may be loaded on or unloaded from the base assembly 20.

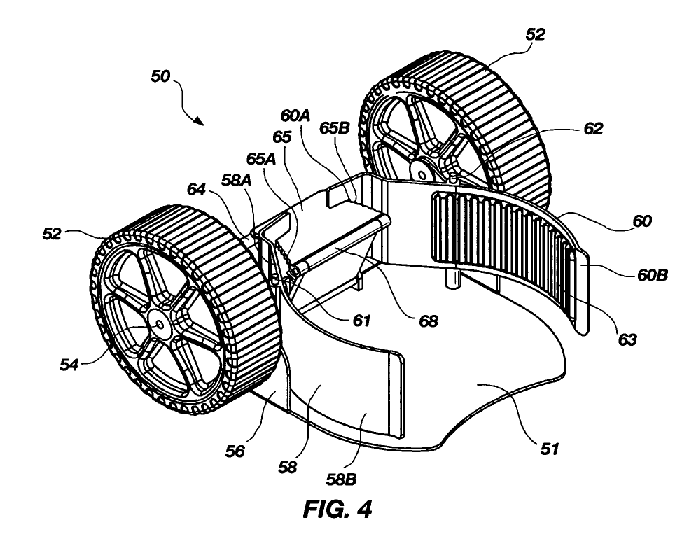

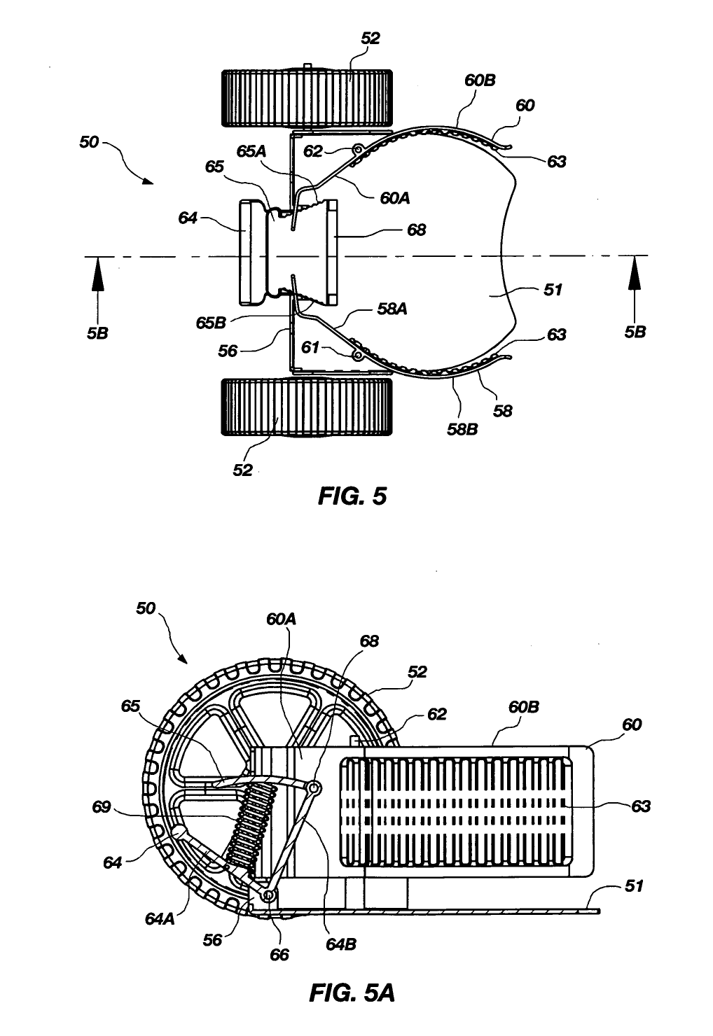

An alternative embodiment of a base assembly 50 according to the present invention is shown in FIGS. 4, 5 and 5A. The base assembly 50 includes bottom support 51, having the same functionality as described above, and a pair of wheels 52 mounted on the ends of an axle 54 connected to a frame 56. Attached to the frame 56 is a first arm 58 and a second arm 60. The first arm 58 and second arm 60 also have a curvature configured and dimensioned to engage a cylindrical body of a tank (not shown) on opposing sides. A pair of posts 61 and 62 extend vertically upward from the bottom support 51. The first arm 58 and second arm 60 are pivotally mounted on posts 61 and 62, respectively.

The first arm 58 and the second arm 60 are each pivotably movable between an open position and a closed position. The open position allows a tank to be loaded on or unloaded from the base assembly 50. When the first arm 58 and second arm 60 are in the closed position, the tank is engaged between the first arm 58 and the second arm 60 and the bottom support 51. A gripping substance 63 may be disposed on an inner portion of each of the first arm 58 and the second arm 60 to enhance the engagement between the first arm 58 and the second arm 60 and a tank. The gripping substance 63 may comprise, without limitation, a resilient material such as rubber or plastic. It will be appreciated that any substance with the desired properties may be used.

A first foot lever 64 and a second foot lever 65 are disposed on the rear of frame 56. As best seen in FIG. 5A, the first foot lever 64 comprises a first portion 64A and a second portion 64B. The intersection of the first portion 64A and the second portion 64B portions forms an angle less than about 90 degrees. Further, at about the intersection of the first portion 64A and the second portion 64B, the first foot lever 64 is pivotally mounted on a shaft 66 to the frame 56.

As best seen in FIGS. 4 and 5, the second foot lever 65 comprises a pair of side edges 65A and 65B. Each of the pair of side edges 65A and 65B includes a plurality of teeth adapted to engage edges 58A and 60A, respectively, located on the rear portions of the first arm 58 and the second arm 60, also respectively. The lateral width of the second foot lever 65 becomes gradually wider from its free end to the portion of the second foot lever 65 nearest the front of the base assembly 50. As shown in FIG. 5A, a spring 69 is interposed between the first foot lever 64 and the second foot lever 65. The first foot lever 64 and the second foot lever 65 are interconnected by a hinge type connection 68 as shown in FIGS. 4, 5 and 5A.

The operation of the first foot lever 64 and the second foot lever 65 will now be explained. The first foot lever 64 and the second foot lever 65 are operable to alter the first arm 58 and the second arm 60 between a open position and a closed position. When the first foot lever 64 is pressed downward, the second foot lever 65 is forced rearward to thereby move the first arm 58 and the second arm 60 to their closed position. In other words, the rear portion 58A of the first arm 58 and the rear portion of 60A of the second arm 60 are forced outward and the front portions 58B and 60B of the first arm 58 and the second arm 60 are forced inward when the first foot lever 64 is pressed downward.

The teeth on the edges 65A and 65B of the second foot lever 65 engage edges 58A and 60A, respectively, in a ratchet type manner to maintain the first arm 58 and the second arm 60 in the closed position. The first arm 58 and the second arm 60 may slightly deform when they are closed tightly around a tank. To release the first arm 58 and the second arm 60 from the closed position, the second foot lever 65 is pressed downward to thereby disengage the teeth on edges 65A and 65B from the edges 58A and 60A, respectively. The first arm 58 and the second arm 60 may pop open due to the deformation incurred when the first arm 58 and the second arm 60 were placed into the closed position.

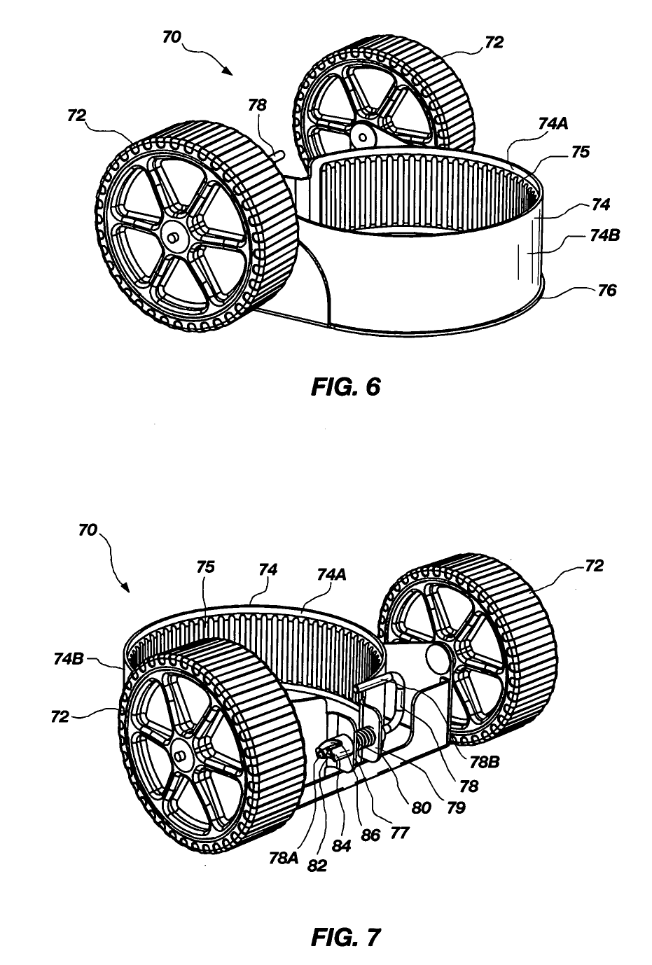

FIGS. 6 and 7 illustrate still another embodiment of a base assembly 70 according to the present invention. Base assembly 70 includes a pair of wheels 72 mounted to the base assembly 70 and a bottom support 76. Each of the wheels 72 may be independently mounted to the base assembly 70. Again, a tank bottom (not shown) may be positioned on the bottom support 76 as previously described. A strap 74 extends around the perimeter of the bottom support 76 and also extends in an upward direction from the bottom support 76. The function of the strap 74 is to secure the base assembly 70 to a tank.

The strap 74 comprises an inner surface 74A and an outer surface 74B. The inner surface 74A engages the lower portion of a cylindrical tank body. The inner surface 74A may have a gripping substance 75 disposed thereon having the function of more securely holding the base assembly 70 onto the tank. As before, the gripping substance 75 is suitable to increase the friction between a tank body and the strap 74 to thereby form a more secure engagement between a tank body and the strap 74.

As best seen in FIG. 7, formed on each of the terminal ends of the strap 74 are flanges 77 and 79. The flanges 77 and 79 extend rearward from the terminal ends of the strap 74. The flanges 77 and 79, and correspondingly the terminal ends of the strap, are separated by a relatively small distance, which may be varied to thereby tighten or loosen the strap 74 from around a tank. A first leg 78A of a substantially u-shaped lever 78 extends through each of the flanges 77 and 79. Disposed on the leg 78A of the lever 78 and between the flanges 77 and 79 is a spring 80. A second leg 78B of the u-shaped lever 78 may be used to move the lever 78. The spring 80 biases the flanges 77 and 79 apart from each other.

A cross member 82 is located on the end of leg 78A of the lever 78. Interposed on the leg 78A and between the cross member 82 and the flange 77 is a sleeve 84. The sleeve 84 includes a pair of helical grooves 86 on each side of the sleeve 84. When the lever 78 is in the raised position, the cross member 82 is positioned on the end of the sleeve 84. It will be appreciated that raising the lever 78 to the raised position brings the flanges 77 and 79 together to thereby tighten the strap 74. When the lever 78 is brought to the lowered position (not explicitly shown) the cross member 82 follows the helical grooves 86 to thereby allow the flanges 77 and 79 to be pushed apart by the spring 80. When the flanges 77 and 79 are pushed apart by the lowering of the lever 78 and the spring 80, the strap 74 is loosened to thereby allow a tank to be removed or installed onto the base assembly 70.

It will be appreciated that the structure and apparatus disclosed herein is merely one example of a means for securing a pair of wheels to a tank, and it should be appreciated that any structure, apparatus or system for securing a pair of wheels to a tank which performs functions the same as, or equivalent to, those disclosed herein are intended to fall within the scope of a means for securing a pair of wheels to a tank, including those structures, apparatuses, or systems for securing a pair of wheels to a tank which are presently known, or which may become available in the future. Anything which functions the same as, or equivalently to, a means for securing a pair of wheels to a tank falls within the scope of this element.

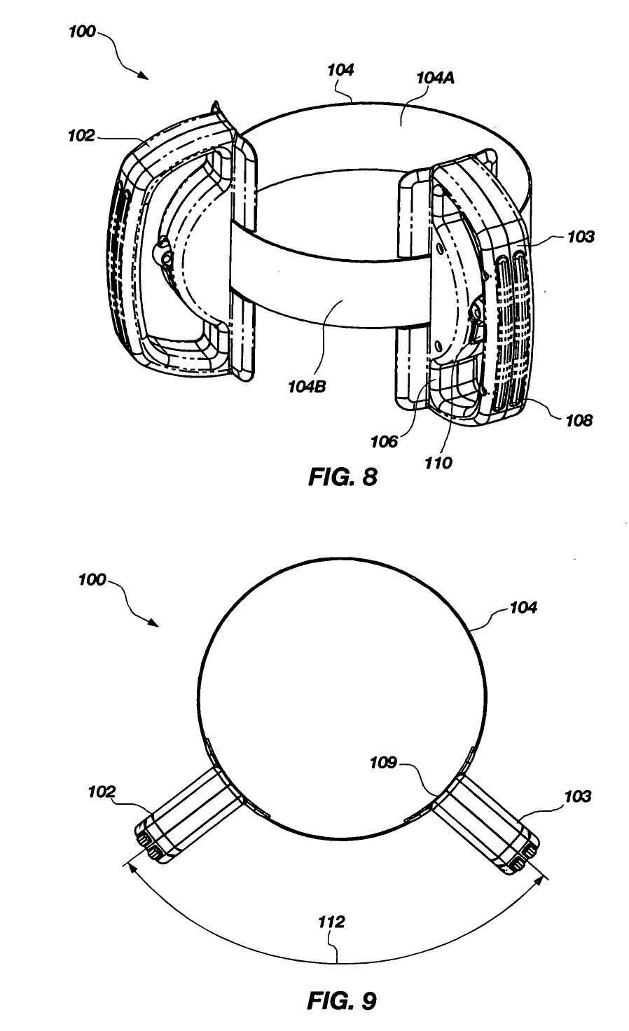

FIGS. 8-11 illustrate the handle assembly 100 shown in FIG. 1. The handle assembly 100 provides a first handle 102 and a second handle 103 for a user to hold while transporting or lifting the tank 10. The handle assembly 100 provides a grip to thereby allow a user to tilt the tank 10 backward such that the tank 10 is only supported by the pair of wheels 22. In this position, the tank 10 may be transported to a new location. In addition, the handles 102 and 103 may be used to facilitate loading and unloading the tank 10 on or off of the base assembly 20.

As can be observed, the handle assembly 100 is not connected to the base assembly 20 by any type of intervening rigid frame or risers. This feature is advantageous over the prior art because it reduces the cost of manufacture as well as the consumption of raw materials. The tank 10 itself provides the necessary support to allow the handle assembly 100 to be effective and makes the tank more portable. Further, as mentioned above, the handle assembly 100 may be used to facilitate loading and unloading the tank 10. Thus, it will be appreciated that the base assembly 20 and the handle assembly 100 may be used separately or in combination.

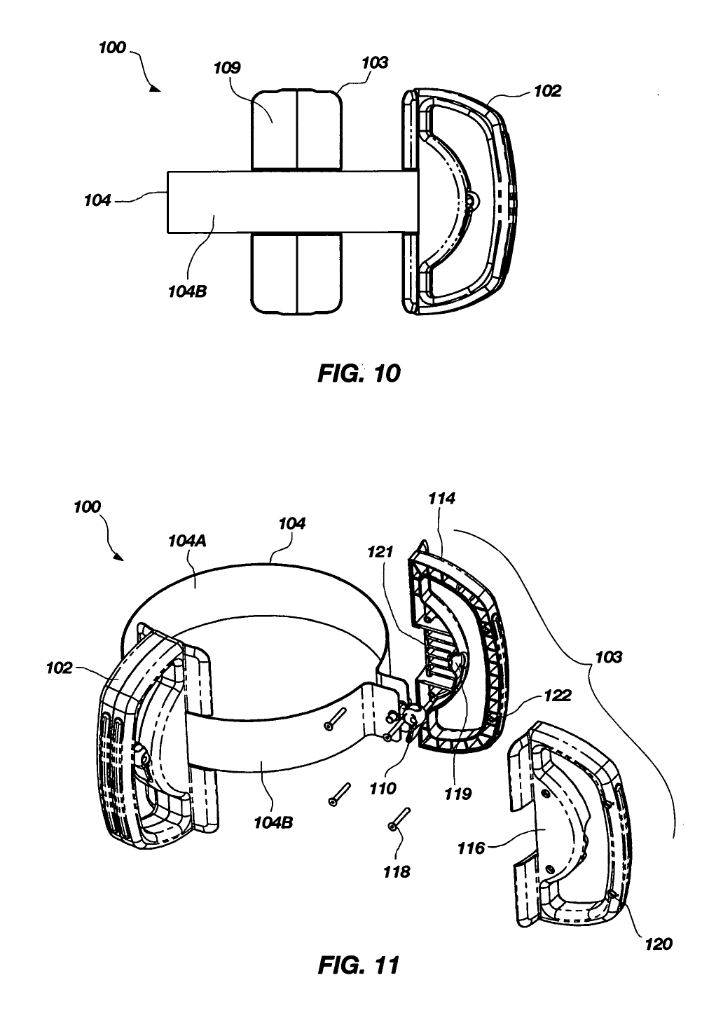

Both the first and second handles, 102 and 103, each comprise a base portion 106 and a handle portion 108. Each handle, 102 and 103, also comprises an elongated back surface 109, as is best seen in FIG. 10, for engaging the sidewall 18 of the tank 10. The elongated back surface 109 has a curvature that is configured and dimensioned to correspond to the curvature of the sidewall 18 of the tank 10 to thereby provide a more solid engagement.

The first and second handles, 102 and 103, are each connected to the strap 104. As previously mentioned, the strap 104 is utilized to secure the handles 102 and 103 to the tank 10. The strap 104 should be of sufficient length to span around the cylindrical body 12 of the tank 10. The strap 104 has an inner surface 104A and an outer surface 104B. The inner surface 104A of the strap 104 engages the sidewall 18 of the cylindrical body 12 of the tank 10. The strap 104 is preferably metal, but may be made out of any material, including nylon, plastic, or the like, as is known to those skilled in the art.

As can best be seen in FIG. 9, the handles 102 and 103 are positioned on the strap 104 such that they are separated by an angle indicated by reference numeral 112. This angle may be around 120 degrees or any angle desired by a user. It should also be noted, while handles 102 and 103 have a vertical orientation, that they may also be configured to have an horizontal orientation.

FIG. 11 shows the second handle 103 disassembled in relation to strap 104. First handle 102 is shown still attached to the strap 104, but may also be disassembled similar to second handle 102, as described herein. The second handle 103 comprises a first side 114 and a second side 116. The first side 114 and the second side 116 are coupled using fasteners 118 to form the base portion 106, handle portion 108, and back surface 109. Fasteners 118 pass through holes 120 in the second side 116 to engage posts 122 correspondingly located in the first side 114. Fasteners 118 may include, without limitation, screws, rivets, bolts, and any other type of fastener known to those skilled in the art.

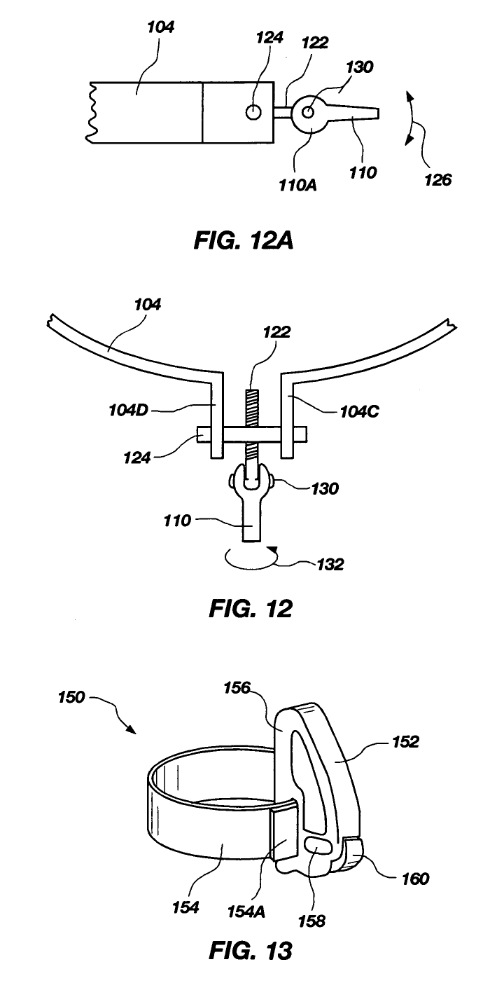

A rounded seat 119 for lever 110 is formed in the second handle 103 when the first side 114 and the second side 116 are assembled together. The lever 110 is functional to tighten and loosen the strap 104 to thereby secure and release the handle assembly 100 to the tank 10. FIG. 12 and FIG. 12A, a top view and a side view, respectively, illustrate the movement of the lever 110 in more detail in relation to strap 104. The terminal ends 104C and 104D of strap 104 are bent to extend substantially radially outward. The terminal ends 104C and 104D are spaced apart. A cavity 121 (see FIG. 11) is formed between the first side 114 and the second side 116 of the second handle 103. The cavity 121 is configured and dimensioned for receiving the terminal ends 104C and 104D of the strap 104.

Referring back to FIGS. 12 and 12A, the lever 110 is pivotally mounted on a threaded shaft 122. Threaded shaft 122 is threaded into a threaded hole (not explicitly shown) in a cross shaft 124. The cross shaft 124 extends crosswise through a pair of holes in the terminal ends 104C and 104D of the strap 104. When the first side 114 and the second side 116 are assembled over the terminal ends 104C and 104D, the cross shaft 124 cannot be removed from the terminal ends 104C and 104D of the strap 104.

The lever 110 comprises a cam portion 110A which is pivotally mounted on a cross piece 130 coupled to a top portion of the threaded shaft 122. The ends of the cross piece 130 extend through opposing sides of the cam portion 110A of the lever 110. The lever 110 may pivot on cross piece 130 between a locked position and an unlocked position as shown by the double arrows indicated by reference numeral 126 in FIG. 12A. When placed in the locked position, the cam portion 110A of the lever 110 pulls cross shaft 124 and the ends 104C and 104D away from the tank 10 to thereby tighten and lock the strap 104 securely around the tank 10.

The relative tightness of the strap 104 around the tank 10 can be adjusted by unlocking the lever 110 and rotating the lever 110 as shown by the arrow marked with the reference numeral 132 in FIG. 12. Twisting the lever 110 in this manner varies the amount the threaded shaft 122 is threaded through the cross shaft 124. It will be appreciated that the adjustment in the relative tightness of the strap 104 allows the handle assembly 100.

The previously described mechanism for securing the handle assembly 100 to the tank 10 will be recognized as a quick release type mechanism. The quick release type mechanism may be incorporated into both the handles 102 and 103. Other types of locking mechanisms may be used as well.

It will be appreciated that the structure and apparatus disclosed herein are merely one example of a means for adjusting the strap size, and it should be appreciated that any structure, apparatus, or system for adjusting the strap size which performs functions the same as, or equivalent to, those disclosed herein are intended to fall within the scope of a means for adjusting the strap size, including those structures, apparatus or systems for adjusting the strap size which are presently known, or which may become available in the future. Anything that functions the same as, or equivalently to, a means for adjusting the strap size falls within the scope of this element.

It will be further appreciated that the structure and apparatus disclosed herein is merely one example of a means for locking the strap around a tank, and it should be appreciated that any structure, apparatus or system for locking the strap which performs functions the same as, or equivalent to, those disclosed herein are intended to fall within the scope of a means for locking the strap, including those structures, apparatus or systems for locking the strap which are presently known, or which may become available in the future. Anything which functions the same as, or equivalently to, a means for locking the strap falls within the scope of this element.

The actual installation of the handle assembly 100 on the tank 10 will now be explained. The handle assembly 100 is connected to the tank 10 by sliding the assembly 100 over the top of the tank 10 to the desired height. The relative tightness of the strap 104 is tightened by twisting lever 110 on the second handle 103 as described above. When the appropriate relative tightness is reached, the lever 110 is pivotally closed to the locked position. The handle assembly 100 is released from the tank 10 by releasing lever 110 to the unlocked position. Again, slight adjustments in the fit of the strap 104 around the tank 10 may be made by twisting lever 110 to thereby increase or decrease tension in the strap 104 if necessary. As mentioned, the handle assembly 100 is also height adjustable to thereby allow the handle assembly 100 to accommodate different users and situations. It should be noted that the handle assembly 100 may also be used without any type of base assembly.

Another illustrative embodiment of a handle assembly 150 is shown in FIG. 13. A handle 152 is attached to a strap 154. The strap 154 has a free end 154A threaded through a base portion 156 of the handle 152. Strap 154 may be tightened by pulling the free end 154A. A clamp or cinch type device (not shown) in the interior of handle 154 prevents the free end 154A from loosening. A button 158 releases the free end 154A of the strap 154 to allow the handle assembly 150 to be released. A roller 160 is attached to handle 152. The roller 160 allows a tank to be rolled while the tank is in a horizontal position.

It will be appreciated that the structure and apparatus disclosed herein are merely one example of a means for securing at least one handle to a tank, and it should be appreciated that any structure, apparatus, or system for securing at least one handle to a tank which performs functions the same as, or equivalent to, those disclosed herein are intended to fall within the scope of a means for securing at least one handle to a tank, including those structures, apparatuses, or systems for securing at least one handle to a tank that are presently known, or that may become available in the future. Anything which functions the same as, or equivalently to, a means for securing at least one handle to a tank falls within the scope of this element.

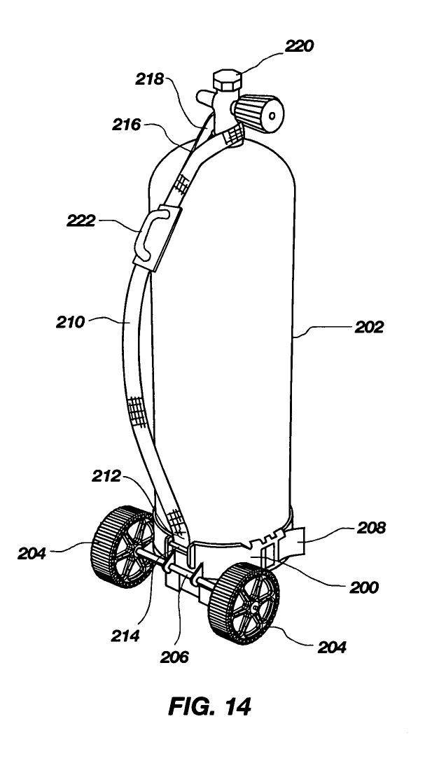

Referring to FIG. 14, there is shown still another embodiment pursuant to the present disclosure. A base assembly 200 is shown installed on a lower end of a tank 202. A pair of wheels 204 are mounted on an axle 206 which is connected to the base assembly 200. A flexible material 208, such as a strap, secures the base assembly 200 to the lower end of the tank 202.

A first portion 214 of the base assembly 200 is adapted to receive a first terminal end 212 of a flexible material 210. The second terminal end 216 is adapted to be attached to an upper portion of the tank 202. For example, the second terminal end 216 may comprise a loop 218 which is placed over the valve assembly 220. A handle 222 may be disposed on the flexible material 210. It will be appreciated that the handle 222 may be placed at any location on the flexible material 210 as desired by the user and that more than one handle may be used. The handle 222 may be formed of any material including plastic and may be secured on the flexible material 210 by threading one of the terminal ends 212 or 216 of the flexible material 210 through a portion of the handle 222. The handle 222 may be slidably adjusted along the length of the flexible material 210. The handle 222 may also be formed by a piece of flexible material having its ends attached to the flexible material 222. In another embodiment, the handle 222 is absent altogether.

It will be appreciated that the flexible material 210 may serve as a sling such that the tank 202 may be lifted and carried by a user. The tension of the flexible material 210 may be somewhat loose to provide the slack necessary for the flexible material 210 to by slung over a shoulder of a user. Alternatively, the tension of the flexible material 210 may be tight. The handle 222 may be used to lift and carry the tank 202 or may be used as a grip to wheel the tank 202 on the base assembly 200.

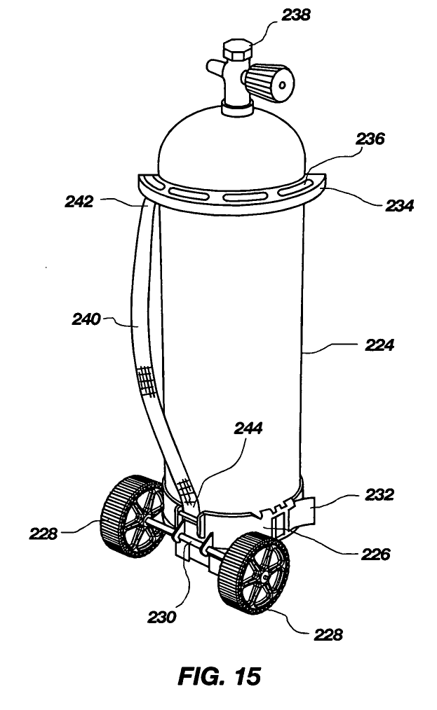

FIG. 15 illustrates another embodiment of the present invention. A tank 224 is shown mounted on a base assembly 226. Again, the base assembly 226 includes a pair of wheels 228 that are mounted on an axle 230 which is connected to the base assembly 226. A flexible material 232, such as a strap, secures the base assembly 226 to the lower end of the tank 224.

A resilient ring 234 is shown installed on the upper portion of the tank 224. The ring 234 may be installed by sliding it over the valve assembly 238 and onto the top portion of the tank 224. The diameter of the ring 234 is radially expandable such that the ring 234 tightly engages the sidewall of the tank 224. The ring 234 is positionable at any location on the tank 224 desired by the user. One or more handles 236 are integrally formed into the ring 234. The handles 236 allow a user to more easily wheel the tank 224 on the base assembly 226. The handles 236 may also allow a user to lift and carry the tank 224.

Another feature of the ring 234 is that due to its resilient nature, the ring 234 may also serve to protect the tank 224 in the event that the tank 224 topples over or is inadvertently dropped while being transported. The ring 234 prevents the tank 224 from directly striking the ground and cushions the tank 224 such that the tank 224 or the valve assembly 238 is not damaged. The ring 234 may be formed of any material having the ability to accomplish one or more of the above stated features.

A flexible material 240 may be interconnected between the base assembly 226 and the ring 234. In particular, a first terminal end 242 of the flexible material 240 is connected to the ring 234 and a second terminal end 244 of the flexible material 240 is connected to the base assembly 226. The flexible material 240 may be used as a sling or a handle to facilitate transport of the tank 224 as previously described in relation to other embodiments of the present disclosure.

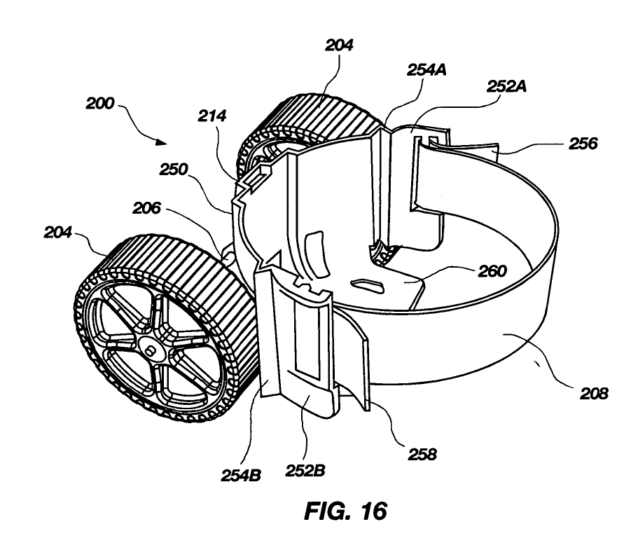

FIG. 16 illustrates an isolated view of the base assembly 200 as shown installed on the tank 202 in FIG. 14. As mentioned, the base assembly 200 includes a pair of wheels 204 mounted on an axle 206. The base assembly 200 includes a frame 250. The frame 250 may be formed of any material, including plastic. Two flexing side members 252A and 252B are attached on opposing sides of the frame 250. The side members 252A and 252B may pivot inward or outward to thereby engage the tank 202 shown in FIG. 14. Disposed between the side members 252A and 252B and the main portion of the frame 250 are living hinges 254A and 254B. The living hinges 254A and 254B allow the flexing side members 252A and 252B to pivot inward to engage the tank 202 or outward to disengage a tank 202. It will be understood that other means for allowing the side members 252A and 252B to pivot inward may be used.

Each of the side members 252A and 252B are adapted to receive the terminal ends 256 and 258 of the flexible material 208. The adaption of the side members 252A and 252B may include a configuration whereby the flexible material 208 may be cinched or otherwise tightened to thereby secure the base assembly 200 onto the tank 202. The cinching of the flexible material 208 pivots inward the side members 252A and 252B against the sidewalls of the tank 202. Further, a bottom support member 260 is also connected to frame 250. The bottom support member 260 is operable to engage and support the bottom of the tank 202.

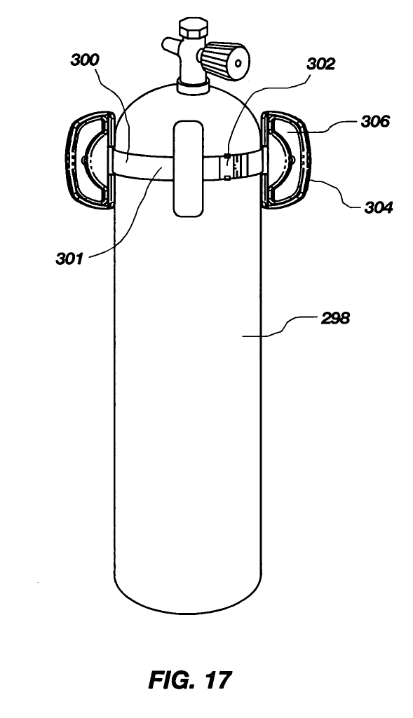

FIG. 17 illustrates a tank protector 300 attached to a tank 298. The tank protector 300 includes a strap 301 secured by a buckle assembly 302. It will be appreciated that the strap 301 may be attached to the tank 298 in various manners as is known to those skilled in the art. A plurality of guard members 304 are disposed on the strap 301 at various locations around the tank 298. The guard members 304 are functional to protect the tank 298 in the event that the tank 298 were to topple over or be dropped. Thus, each of the guard members 304 is formed of a suitable material to protect the tank 298 in the event that the tank topples over. One or more of the guard members 304 may include a handle 306.

The placement of the guard members 304 may be such that no matter which direction the tank 298 were to fall, the guard members 304 would protect the tank 298 from directly striking the ground or other objects. It should be noted that the guard members 304 may be of any shape capable of carrying out any one of the features described above and they are not limited to any particular shape.

It will be appreciated that the tank protector 300 and the ring 234 are embodiments of types of handle assemblies and may be referred to herein as such. Further, those having ordinary skill in the relevant art will appreciate the advantages provided by the features of the present invention. For example, it is a feature of an illustrative embodiment of the present invention to provide a base assembly having a pair of wheels. Another feature of an illustrative embodiment of the present invention is to provide a handle assembly having one or more handles to facilitate tank transport. It is a further feature of an illustrative embodiment of the present invention, in accordance with one aspect thereof, to provide a base assembly having a means for securing itself to a lower portion of a tank. It is still another feature of an illustrative embodiment of the present invention to provide a handle assembly with a wheeled handle.

It should be noted that a tank dolly device in accordance with the principles of the present invention may be manufactured from a variety of different materials, including, without limitation, metal, plastic and the like.

In the foregoing Detailed Description, various features of the present disclosure are grouped together in single embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly, and use may be made without departing from the principles and concepts set forth herein.

The subject matter claimed is:

1. An apparatus for transporting a tank, the tank having a top, a bottom, and a sidewall, said apparatus comprising:
a base assembly configured and dimensioned to removably engage the bottom of the tank, the base assembly comprising a pair of wheels mounted to a frame; and
a handle assembly configured and dimensioned to removably engage the sidewall of the tank, the handle assembly comprising at least one handle;
wherein the base assembly and the handle assembly are not rigidly interconnected to each other.

2. The apparatus of claim 1 wherein the base assembly further comprises a coupling mechanism to secure the frame of the base assembly to the tank.

3. The apparatus of claim 2 wherein the coupling mechanism comprises at least one arm operable between an open position and a closed position, the at least one arm securing the tank to the frame when the at least one arm is in the closed position.

4. The apparatus of claim 2 wherein the coupling mechanism comprises an arm having a first end and a second end, the first end of the arm being pivotally coupled to the frame.

5. The apparatus of claim 4 wherein the coupling mechanism further comprises a mechanism for maintaining the arm in a closed position around a tank.

6. The apparatus of claim 2 wherein the coupling mechanism comprises a first arm and a second arm both of which are pivotally mounted to the frame, the first and second arms each operable between an open position and a closed position.

7. The apparatus of claim 6 wherein the coupling mechanism further comprises a first lever, the first lever operable to move the first and second arms from the open position to the closed position.

8. The apparatus of claim 7 further comprising a ratchet mechanism to facilitate closing the first and second arms.

9. The apparatus of claim 8 wherein the coupling mechanism further comprises a second lever, the second lever operable to disengage the ratchet mechanism to thereby release the first and second arms from the closed position.

10. The apparatus of claim 2 wherein the coupling mechanism comprises a strap.

11. The apparatus of claim 10 wherein the strap is comprised of a material selected from the group consisting of metal, flexible material, and plastic.

12. The apparatus of claim 10 wherein the coupling mechanism further comprises a lever, the lever being operable to tighten the strap.

13. The apparatus of claim 10 further comprising a cinch mechanism for tightening the strap.

14. The apparatus of claim 10 further comprising a grip enhancement substance disposed on the strap.

15. The apparatus of claim 1 wherein the base assembly further comprises a means for securing the frame of the base assembly to the tank.

16. The apparatus of claim 1 wherein the handle assembly further comprises a strap to secure the handle assembly to the sidewall of the tank.

17. The apparatus of claim 16 wherein the strap is comprised of a material selected from the group consisting of metal, flexible material, and plastic.

18. The apparatus of claim 16 wherein the handle assembly further comprises a mechanism for tightening the strap around the tank.

19. The apparatus of claim 18 wherein the mechanism is a quick release mechanism.

20. The apparatus of claim 19 wherein the quick release mechanism is incorporated into a handle.

21. The apparatus of claim 16 wherein the handle assembly comprises a radially expandable ring.

22. The apparatus of claim 21 wherein the ring is formed from a resilient material.

23. The apparatus of claim 16 wherein the handle assembly comprises a means for protecting the tank in the event that the tank topples over or is dropped.

24. The apparatus of claim 23 wherein the means for protecting the tank comprises a plurality of guards attached to the handle assembly.

25. The apparatus of claim 24 wherein one or more of the guards comprises a handle.

26. The apparatus of claim 1 wherein the handle assembly comprises two handles attached to a strap.

27. The apparatus of claim 1 wherein the at least one handle comprises a roller such that the tank may be rolled in a horizontal position.

28. The apparatus of claim 1 further comprising a flexible material interconnected between the handle assembly and the base assembly.

29. The apparatus of claim 28 further comprising a handle coupled to the flexible material.

30. An apparatus for transporting a tank, the tank having a top, a bottom, and a sidewall, said apparatus comprising:
a base assembly configured and dimensioned to removably engage the tank, the base assembly comprising a pair of wheels and a frame, said frame comprising a bottom support member for engaging the bottom of the tank and a side support member for engaging the sidewall of the tank;
a coupling mechanism for securing the tank to the frame of the base assembly;
a handle assembly configured and dimensioned to removably engage the tank, the handle assembly comprising at least one handle and a strap, the strap operable to secure the at least one handle to the tank;
wherein the base assembly and the handle assembly are separately attachable to the tank.

31. The apparatus of claim 30 wherein the coupling mechanism comprises at least one arm pivotally attached to the frame, the at least one arm operable between an open position and a closed position, the at least one arm securing the tank to the frame when the at least one arm is in the closed position.

32. The apparatus of claim 31 wherein the base assembly further comprises a fastener, the fastener operable to secure the at least one arm in the closed position.

33. The apparatus of claim 31 wherein the at least one arm comprises two arms.

34. The apparatus of claim 30 wherein the at least one handle comprises two handles.

35. The apparatus of claim 30 wherein the handle assembly further comprises a mechanism to tighten and maintain the strap tightly around the tank.

36. The apparatus of claim 35 wherein the mechanism is a quick release mechanism.

37. The apparatus of claim 36 wherein the quick release mechanism is incorporated into a handle.

38. The apparatus of claim 30 wherein the coupling mechanism further comprises a pair of arms and a first lever, the first lever operable to close the pair of arms around the tank.

39. The apparatus of claim 38 further comprising a ratchet mechanism to prevent the pair of arms from opening.

40. The apparatus of claim 39 wherein the coupling mechanism further comprises a second lever, the second lever operable to disengage the ratchet mechanism to thereby release the pair of arms.

41. The apparatus of claim 30 wherein the coupling mechanism comprises a strap.

42. The apparatus of claim 41 wherein the coupling mechanism further comprises a lever, the lever being operable to tighten the strap.

43. The apparatus of claim 41 further comprising a grip enhancement substance disposed on the strap.

44. The apparatus of claim 30 wherein the handle assembly further comprises a means for adjusting the strap such that the handle assembly may be mounted on tanks of varying size.

45. The apparatus of claim 30 wherein the handle assembly further comprises a means for locking the strap.

46. An apparatus for transporting a tank, the tank having a top, a bottom and a sidewall, said apparatus comprising:
a means for securing a pair of wheels to the bottom of the tank; and
a means for securing at least one handle to the tank;
wherein the first and second means are not rigidly interconnected.

47. The apparatus of claim 46 further comprising a means for protecting the tank from directly striking a surface in the event that the tank topples over.

48. An apparatus for transporting a tank, the tank having a top portion, a bottom portion, and a sidewall, said apparatus comprising:
a base assembly configured and dimensioned to removably engage the bottom portion of the tank, the base assembly comprising a pair of wheels mounted to a frame; and
a strap having a first end and a second end;
wherein the first end of the strap is attached to the base assembly and the second end of the strap is configured to be directly or indirectly affixed to the tank.

49. The apparatus of claim 48 wherein the second end of the strap comprises a loop.

50. The apparatus of claim 48 further comprising one or more handles coupled to the strap.

51. The apparatus of claim 48 further comprising a handle assembly configured and dimensioned to removably engage the sidewall of the tank, the handle assembly comprising at least one handle, and wherein the second end of the strap is coupled to the handle assembly.

52. The apparatus of claim 51 further comprising one or more handles coupled to the strap.

53. The apparatus of claim 48 further comprising a tank protection device configured and dimensioned to removably engage the sidewall of the tank, the tank protection device protecting the tank from directly striking a surface in the event that the tank topples over, and wherein the second end of the strap is coupled to the tank protection device.

54. The apparatus of claim 53 wherein the tank protection device comprises one or more guard members disposed on a strap.

55. The apparatus of claim 53 wherein the tank protection device comprises an expandable ring formed of a resilient material.

56. The apparatus of claim 55 further comprising one or more handles formed in the resilient material.

57. The apparatus of claim 48 wherein the base assembly further comprises a coupling mechanism for securing the tank to the base assembly.
